(19) United States
(12) Patent Application Publication
(10) Pub. No.: US 2006/0291634 A1
(43) Pub. Date: Dec. 28, 2006

(54) TELEPHONE APPARATUS AND METHOD CAPABLE OF PLAYING A SPECIFIC RING BACK TONE

(76) Inventor: Sheng-En Yeh, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/160,977

(22) Filed: Jul. 18, 2005

(30) Foreign Application Priority Data
Apr. 29, 2005 (TW) 094113893

(51) Int. Cl. H04M 1/64; H04M 3/42; H04M 15/06

(52) U.S. Cl. 379/142.01; 379/67.1; 379/202.01

(57) ABSTRACT

A telephone apparatus capable of playing a specific ring back tone and a method for controlling a telephone apparatus to play a specific ring back tone are disclosed. The method includes: setting a user setting to assign the telephone apparatus to adopt a specific ring back tone; and deciding to allow or to not allow the telephone apparatus to play the specific ring back tone according to the user setting when the telephone apparatus attempts to establish a connection with another telephone apparatus.

### BACKGROUND OF THE INVENTION

1. Field of the Invention

The present invention relates to a telephone apparatus and a related method, and more specifically, to a telephone apparatus capable of playing a specific ring back tone, and the present invention relates to a related method.

2. Description of the Prior Art

In the modern information society with highly developed communication systems, people popularly utilize convenient, portable, and handy mobile phones in their daily communications. People can exchange information, share experiences, and communicate with each other by convenient mobile phones whenever and wherever. Because mobile phones are increasingly popular, telecommunication service providers and mobile phone manufacturers develop easier and simpler operations for the control of mobile phones. Additionally, the providers and manufacturers provide users with more user-friendly communication services.

A common telecommunication service is taken for example. The telecommunication service is that a telecommunication service provider provides several ring back tones from which the users can select. Therefore, when a user A activates the above-mentioned service, the person making a phone call to the user A can hear the ring back tone selected by the user A, not a typical ring back tone. The aforementioned selected ring back tone can be various, such as a pop song, a voice message, or even any kind of sounds.

The operation theory of the above-mentioned service is uncomplicated. Please refer to FIG. 1. FIG. 1 is a block diagram of a public switched telephone network (PSTN) 10 according to a related art. The PSTN 10 comprises: switches 12, 14, and a base station 16. The switch 14 is a telephone switch, and the switch 12 is a switch provided by the telecommunication service provider. When some person utilizes a telephone 22 to dial a telephone number of a user A's mobile phone 24, the telephone 22 must establish a connection with the mobile phone 24 via the switches 14 and 12. When the connection between the telephone 22 and the mobile phone 24 is being established and before the users A and C begin to talk to each other, the switch 12 provided by the telecommunication service provider will transmit the ring back tone selected by the user A to the telephone 22. In this way, the telephone 22 will play the ring back tone selected by the user A. If another user B does not utilize the above-mentioned service, when some person utilizes the telephone 22 to dial a telephone number of the user B's mobile phone 26, the caller will hear a default ring back tone (i.e., a typical ring back tone).

The above-mentioned service can choose different ring back tones according to a user's preference, and hence the personal style of the user can be sufficiently expressed; however, a person who initiates a phone call to the user may not enjoy the ring back tone that has been selected by the user (i.e., the phone's owner).

### SUMMARY OF THE INVENTION

The claimed invention is therefore to provide a telephone apparatus capable of playing a specific ring back tone and a related method, and the specific ring back tone is decided by a person who initiates the phone call.

According to the claimed invention, a method for controlling a telephone apparatus to play a specific ring back tone is disclosed. The method comprises: setting a user setting to assign the telephone apparatus to adopt a specific ring back tone; and deciding to allow or not to allow the telephone apparatus to play the specific ring back tone according to the user setting when the telephone apparatus attempts to establish a connection with another telephone apparatus.

In addition, the claimed invention provides a telephone apparatus capable of playing a specific ring back tone. The telephone apparatus comprises: a memory unit for recording a user setting and a specific ring back tone; and a ring back tone control unit for deciding to play the specific ring back tone or not to play the specific ring back tone according to the user setting when the telephone apparatus attempts to establish a connection with another telephone apparatus.

In the claimed invention, a specific ring back tone is recorded in a telephone apparatus, and therefore when the telephone apparatus attempts to establish a connection with another telephone apparatus, it can play the specific ring back tone. A plurality of ring back tones can be recorded in the telephone apparatus beforehand to allow a user to hear different ring back tones according to the user's preference.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a PSTN according to a related art.

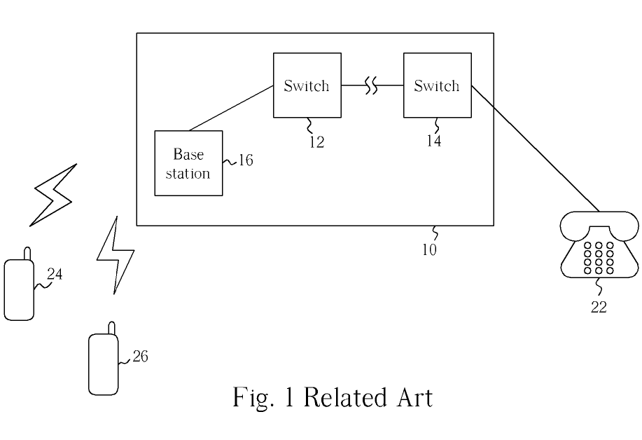

FIG. 2 is a functional block diagram of an embodiment of a telephone apparatus according to the present invention.

FIG. 3 is a flowchart of an embodiment of the method for playing a ring back tone according to the present invention.

### DETAILED DESCRIPTION

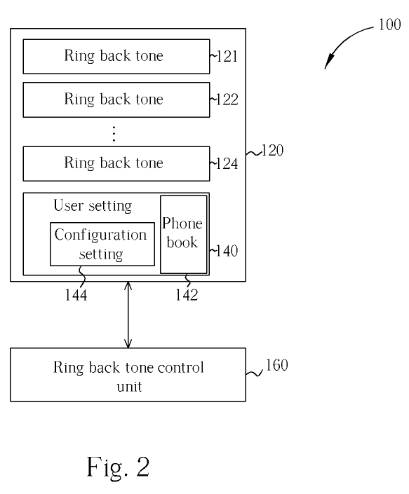

Please refer to FIG. 2. FIG. 2 is a functional block diagram of an embodiment of a telephone apparatus 100 according to the present invention. In the present embodiment, the telephone apparatus 100 is a mobile phone and comprises a memory unit 120 and a ring back tone control unit 160. In the present embodiment, the memory unit 120 is utilized for recording a plurality of ring back tones 121, 122, 124 and a user setting 140. The user setting 140 comprises a phone book 142 and a configuration setting 144. The configuration setting 144 is utilized for recording information about a user preference for activating the function of playing a specifically selected ring back tone or not playing a specifically selected ring back tone. This means playing the ring back tones 121, 122, 124 stored in the memory unit 120 or playing the default ring back tone transmitted by the switch. The phone book 142 is utilized for recording a plurality of phone numbers n1, n2 and the ring back tones respectively corresponding to the phone numbers n1, n2.

Assume that the phone number n1 corresponds to the ring back tone 122, and the phone number n2 corresponds to the ring back tone 124. When the telephone apparatus 100 dials the phone number n1, the ring back tone control unit 160 determines to activate or not to activate the function of playing a user's personally selected ring back tone according to the configuration setting 144. If yes, the ring back tone control unit 160 will further look up the ring back tone 122 corresponding to the phone number n1 in the phone book 142. Finally, the ring back tone control unit 160 reads and plays the ring back tone 122 that is stored in the memory unit 120. Please note that the configuration setting 144 can also be utilized for identifying the basic ring back tone of the telephone apparatus 100. Assume that in the present embodiment, the basic ring back tone is the ring back tone 121. When the phone number dialed by the telephone apparatus 100 are different from each one of the phone numbers n1, n2 stored in the phone book 142, the ring back tone control unit 160 will play the ring back tone 121.

It should be noted that the operation of the ring back tone control unit 160 according to the present invention changes according to the design of the PSTNs in many different areas. For example, a PSTN utilized in Taiwan transmits the above-mentioned default ring back tone to a caller's telephone apparatus when it attempts to establish a connection with another telephone apparatus. In this way, after the ring back tone control unit 160 receives the default ring back tone, the ring back tone control unit 160 starts to play the selected ring back tone. However, some PSTNs utilized in some areas transmit a ring back tone control signal via a data transmission channel to a caller's telephone apparatus to drive the caller's telephone apparatus to play a default ring back tone, and not to directly transmit the default ring back tone back. In this way, the ring back tone control unit 160 has to receive the ring back tone control signal first and then start to play the user's personally selected ring back tone. In addition, the telephone apparatus according to the present invention is not limited to the present embodiment. The present invention works with and is compatible in concept with other telephone apparatuses such as those with memory functions, such as a Voice over IP (VoIP) phone or a digital phone.

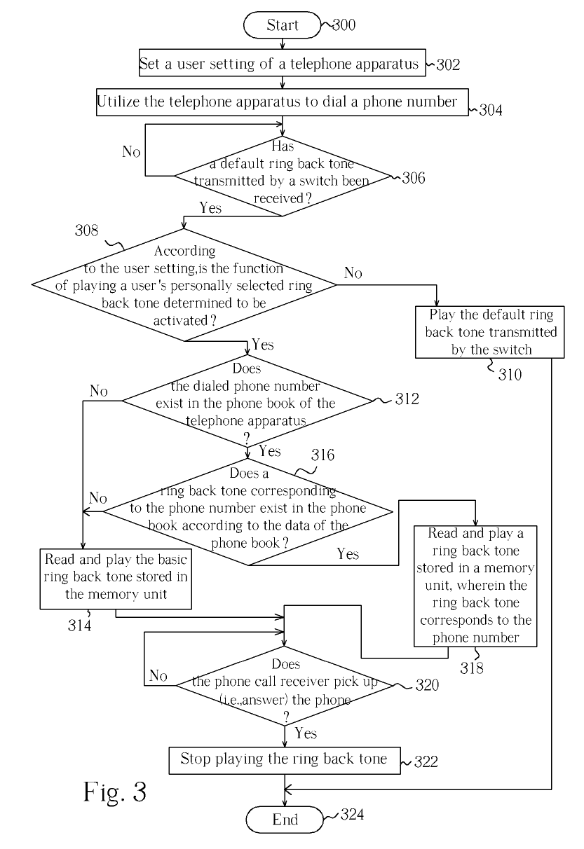

Please refer to FIG. 3. FIG. 3 is a flowchart of an embodiment of the method for playing a ring back tone according to the present invention. As shown in FIG. 3, the present embodiment comprises the following steps:

Step 300: Start.

Step 302: Set a user setting of a telephone apparatus.

Step 304: Utilize the telephone apparatus to dial a phone number.

Step 306: Has a default ring back tone transmitted by a switch been received? If so, proceed to step 308; otherwise, repeat step 306.

Step 308: According to the user setting, is the function of playing a user's personally selected ring back tone determined to be activated? If yes, proceed to the step 312; otherwise, proceed to step 310.

Step 310: Play the default ring back tone transmitted by the switch; proceed to step 324.

Step 312: Does the dialed phone number exist in the phone book of the telephone apparatus? If so, proceed to step 316; otherwise, proceed to step 314.

Step 314: Read and play the basic ring back tone stored in the memory unit; proceed to step 320.

Step 316: Does a ring back tone corresponding to the phone number exist in the phone book according to the data of the phone book? If so, proceed to step 318; otherwise, proceed to step 314.

Step 318: Read and play a ring back tone stored in a memory unit, wherein the ring back tone corresponds to the phone number.

Step 320: Does the phone call receiver pick up (i.e., answer) the phone? If so, proceed to step 322; otherwise, repeat step 320.

Step 322: Stop playing the ring back tone.

Step 324: End.

The method of playing a ring back tone according to the present invention includes the operation flow of the telephone apparatus 100 shown in FIG. 2. As shown in FIG. 3, the user utilizing the telephone apparatus must set a user setting first (step 302), wherein the user setting includes many kinds of information; for example, the information about if the user's preference is to activate or not activate the function of playing the user's own selected ring back tone as well as the basic ring back tone of the telephone apparatus. When the user utilizes the telephone apparatus to dial a phone number (step 304) and to receive the default ring back tone transmitted by the a switch (step 306), the telephone apparatus decides, according to the user setting, to activate or not activate the function of playing the user's own selected ring back tone. If the function is not activated, the telephone apparatus directly plays the default ring back tone transmitted by the switch (step 310); otherwise, the telephone apparatus further determines if the phone number exists in the phone book by looking up the phone number in the phone book (step 312), and if the phone number is set to correspond to a specific ring back tone (step 316). If the phone number exists in the phone book and corresponds to a specific ring back tone, the telephone apparatus directly plays the specific ring back tone (step 318). If not, the telephone apparatus plays the preset basic ring back tone (step 314). Finally, when the phone call receiver picks up (i.e., answers) the phone, the telephone apparatus stops playing the specific ring back tone or the basic ring back tone. Please note that the step 306 according to the present invention can be changed to be: “If a ring back tone control signal transmitted by a switch has been received?” according to a different PSTN.

In contrast to the related art, the telephone apparatus according to the present invention records a specific ring back tone. Therefore, when the telephone apparatus attempts to establish a connection with another telephone apparatus, the telephone apparatus can play the selected specific ring back tone. The telephone apparatus according to the present invention can record a plurality of ring back tones allowing the user, based on preference, to hear various and different ring back tones. The user may divide the plurality of phone numbers into several groups in the phone book, and set the different groups of phone numbers to correspond to different ring back tones, respectively. In this way, when the user incautiously dials the wrong phone number, it can be easily discovered that there has been a dialing mistake according to the played ring back tone. This function will help the user avoid many occurrences of misunderstandings.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a telephone apparatus to play a specific ring back tone, comprising:
setting a user setting to assign the telephone apparatus to adopt a specific ring back tone; and
deciding to allow or not to allow the telephone apparatus to play the specific ring back tone according to the user setting when the telephone apparatus attempts to establish a connection with another telephone apparatus.

2. The method of claim 1, wherein the user setting is set to record a specific phone number corresponding to the specific ring back tone; and the telephone apparatus plays the specific ring back tone when the another telephone apparatus corresponds to the specific phone number.

3. The method of claim 2, wherein the user setting comprises a phone book that is utilized for recording the relationship between the specific phone number and the corresponding specific ring back tone.

4. The method of claim 1, further comprising:
when the telephone apparatus attempts to establish a connection with another telephone apparatus, the telephone apparatus begins playing the specific ring back tone if the telephone apparatus has received a ring back tone control signal outputted by a switch.

5. The method of claim 1, further comprising:
receiving an output signal generated by a switch; and
determining if the output signal contains a default ring back tone after the output signal is received; if so, the telephone apparatus decides to play the specific ring back tone.

6. The method of claim 1, wherein the telephone apparatus is a mobile phone.

7. A telephone apparatus capable of playing a specific ring back tone, comprising:
a memory unit for recording a user setting and a specific ring back tone; and
a ring back tone control unit for deciding to play the specific ring back tone or not to play the specific ring back tone according to the user setting when the telephone apparatus attempts to establish a connection with another telephone apparatus.

8. The telephone apparatus of claim 7, wherein the ring back tone control unit controls to play the specific ring back tone when the another telephone apparatus corresponds to the specific phone number.

9. The telephone apparatus of claim 8, wherein the user setting comprises a phone book that is utilized for recording the relationship between the specific phone number and the corresponding specific ring back tone.

10. The telephone apparatus of claim 7, wherein the ring back tone control unit controls to play the specific ring back tone after the ring back tone control unit receives a ring back tone control signal outputted by a switch.

11. The telephone apparatus of claim 7, wherein the ring back tone control unit is further utilized for receiving an output signal generated by a switch, and determining if the output signal contains a default ring back tone; if so, the ring back tone control unit controls to play the specific ring back tone.

12. The telephone apparatus of claim 8, being a mobile phone.
